(19) United States
(12) Patent Application Publication
(10) Pub. No.: US 2025/0094683 A1
(43) Pub. Date: Mar. 20, 2025

(54) METHOD, APPARATUS, STORAGE MEDIUM, AND ELECTRONIC DEVICE FOR CONTENT PRESENTING

(71) Applicant: Beijing Youzhuju Network Technology Co., Ltd., Beijing (CN)

(72) Inventor: Sheng Jiang, Beijing (CN)

(21) Appl. No.: 18/729,495

(22) PCT Filed: Jan. 12, 2023
(86) PCT No.: PCT/CN2023/071866

§ 371 Date: Jul. 16, 2024

(30) Foreign Application Priority Data
Jan. 20, 2022 (CN) 202210068507.5

(51) Int. Cl. G06F 40/103; G06F 9/451

(52) U.S. Cl. CPC G06F 40/103; G06F 9/451

(57) ABSTRACT

The disclosure relates to a method, apparatus, storage medium, and electronic device for content presenting. The method includes: in response to a triggering operation for a content box within a first page, determining a first display parameter of the content box within the first page, a position parameter of the first page within a second page, and a second display parameter of the second page. Herein, the first page is embedded into the second page through an iframe label for presenting; determining a position offset of the content box relative to the second page based on the first display parameter, the second display parameter, and the position parameter, the position offset being for controlling the content box to be presented within the second page in a centered manner; and presenting, based on the position offset, the content box within the second page in a centered manner.

This application claims priority to Chinese Patent Application No. 202210068507.5, filed on Jan. 20, 2022, and entitled “METHOD, APPARATUS, STORAGE MEDIUM, AND ELECTRONIC DEVICE FOR CONTENT PRESENTING”, which is incorporated herein by reference in its entirety.

### FIELD

The present disclosure relates to the technical field of computers, and particularly relates to a method, apparatus storage medium, and an electronic device for content presenting.

### BACKGROUND

In the inheritance of a plurality of business system pages, subsystem pages are often embedded into parent system pages through iframe labels. However, due to independence of the iframe labels, components and styles of the subsystem pages embedded through the iframe labels are isolated from the parent system pages. Therefore, if a modal box is triggered in the subsystem page embedded through the iframe label, the modal box will be presented in a centered manner relative to the subsystem page, but not relative to the parent system page.

However, in an actual business scenario, it is expected that the modal box is centered relative to the parent system page. Therefore, in the related art, the iframe labels are usually given up, and the subsystem page and the parent system page are integrally developed, which increases unnecessary page development costs.

### SUMMARY

This summary section is provided to introduce the concepts in a simplified form that are described in detail in the section of detailed description. This summary section is not intended to identify key features or essential features of the claimed technical solutions, nor is it intended to be used to limit the scope of the claimed technical solutions.

In a first aspect, the present disclosure provides a method of content presenting, comprising:
in response to a triggering operation for a content box within a first page, determining a first display parameter of the content box within the first page, a position parameter of the first page within a second page, and a second display parameter of the second page, the first page being embedded into the second page through an iframe label for presenting;
determining a position offset of the content box relative to the second page based on the first display parameter, the second display parameter, and the position parameter, the position offset being for controlling the content box to be presented within the second page in a centered manner; and
presenting, based on the position offset, the content box within the second page in a centered manner.

In a second aspect, the present disclosure provides an apparatus for content presenting, comprising:
a first determining module configured to, in response to a triggering operation for

a content box within a first page, determine a first display parameter of the content box within the first page, a position parameter of the first page within a second page, and a second display parameter of the second page, the first page being embedded into the second page through an iframe label for presenting;
a second determining module configured to determine a position offset of the content box relative to the second page based on the first display parameter, the second display parameter, and the position parameter, the position offset being for controlling the content box to be presented within the second page in a centered manner; and
a first presenting module configured to present, based on the position offset, the content box within the second page in a centered manner.

In a third aspect, the present disclosure provides a computer-readable medium having a computer program stored thereon, wherein the program, when executed by a processing device, implements the steps of the method in the first aspect.

In a fourth aspect, the present disclosure provides an electronic device, comprising:
a storage device having a computer program stored thereon; and
a processing device for executing the computer program in the storage device to implement the steps of the method in the first aspect.

Through the above technical solutions, in response to a triggering operation for a content box, a first display parameter of the content box within the first page, a position parameter of the first page within a second page, and a second display parameter of the second page may be determined. Then a position offset of the content box relative to the second page is determined based on the first display parameter, the second display parameter, and the position parameter. Therefore, the content box is presented within the second page in a centered manner based on the position offsets. That is, the content box triggered within the first page may be presented within the second page in a centered manner in a scenario of page embedding through the iframe label, which can reduce the page development cost and improve the page development efficiency compared with a mode of integrated development in the related art.

Other features and advantages of the present disclosure will be described in detail in the subsequent detailed description section.

### BRIEF DESCRIPTION OF THE SEVERAL VIEWS OF THE DRAWINGS

The foregoing and other features, advantages, and aspects of various embodiments of the present disclosure will become more apparent in conjunction with the accompanying drawings and with reference to the following specific embodiments. Throughout the accompanying drawings, the same or similar numerals indicate the same or similar elements. It should be understood that the accompanying drawings are schematic and that the parts and elements are not necessarily drawn to scale. In the accompanying drawings:

FIG. 1 is a schematic diagram of page embedding through an iframe label in the related art;

FIG. 2 is a schematic diagram of presenting a modal box in a subsystem page in one related art;

FIG. 3 is a flowchart of a method of content presenting according to an example embodiment of the present disclosure;

FIG. 4 is a schematic diagram of presenting a modal box in a method of content presenting according to an example embodiment of the present disclosure;

FIG. 5 is a schematic diagram of comparison in presenting a message box in a method of content presenting according to an example embodiment of the present disclosure and in the related art;

FIG. 6 is a schematic diagram of determining a first display parameter, a position parameter and a second display parameter in a method of content presenting according to an example embodiment of the present disclosure;

FIG. 7 is a schematic diagram of comparison in a process of presenting of a modal box in a method of content presenting according to an example embodiment of the present disclosure and in the related art;

FIG. 8 is a schematic diagram of presenting a modal box in a subsystem page in another related art;

FIG. 9 is a schematic diagram of presenting a modal box in a method of content presenting according to another example embodiment of the present disclosure;

FIG. 10 is a block diagram of an apparatus for content presenting according to an example embodiment of the present disclosure; and

FIG. 11 is a block diagram of an electronic device according to an example embodiment of the present disclosure.

### DETAILED DESCRIPTION

The embodiments of the present disclosure will be described below with reference to the drawings. Although the drawings illustrate some embodiments of the present disclosure, it should be understood that the present disclosure may be implemented in various forms and is not limited to the embodiments set forth herein. It should be understood that the drawings and the embodiments of the present disclosure are only used for illustrative purposes and are not intended to limit the protection scope of the present disclosure.

It should be understood that the steps described in the method embodiments of the present disclosure may be executed in different sequences and/or in parallel. In addition, the method implementation modes may comprise additional steps and/or omit the execution of the shown steps. The scope of the present disclosure is not limited in this regard.

As used herein, term “comprise” and its variants should be open-ended, i.e., “comprising but not limited to”. Term “based on” means “based at least in part on”. Term “one embodiment” means “at least one embodiment”; term “another embodiment” means “at least one additional embodiment”; and term “some embodiments” means “at least some embodiments”. Relevant definitions of other terms will be provided in the following text.

It needs to be noted that concepts such as “first”, “second”, and the like mentioned in the present disclosure are only used to distinguish different apparatuses, modules or units, and are not used to limit the order of functions performed by these apparatuses, modules or units, or interdependence relationship.

It should be noted that terms “one” and “plurality of” mentioned in the present disclosure are illustrative and not restrictive, and one skilled in the art should understood that the terms should be understood as “one or more” unless the context clearly indicates otherwise.

The names of massages or information exchanged among a plurality of apparatuses in the embodiments of the present disclosure are only for illustrative purpose and are not used to limit the range of these messages or the information.

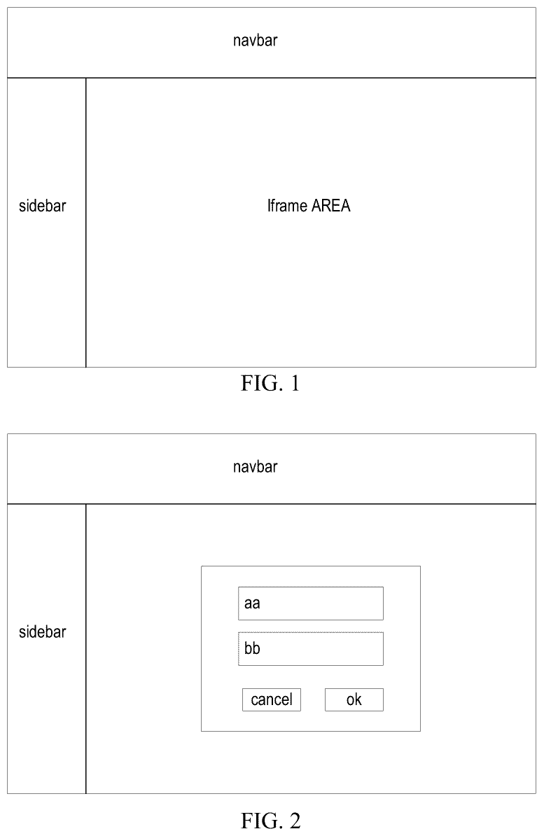

As mentioned in the background art, in the inheritance of a plurality of business system pages, subsystem pages are often embedded into parent system pages through iframe labels. However, due to independence of the iframe labels, components and styles of the subsystem pages embedded through the iframe labels are isolated from the parent system pages. Therefore, if a modal box is triggered in the subsystem page embedded through the iframe label, the modal box will be presented in a centered manner relative to the subsystem page, but not relative to the parent system page. For example, referring to FIG. 1, the parent system page is a whole page, and the subsystem page is an iframe area within the whole page. Then referring to FIG. 2, if the modal box is triggered in the subsystem page, the modal box will be centered relative to the subsystem page (i.e., the iframe area), but not relative to the whole page.

However, in an actual business scenario, it is expected that the modal box is centered relative to the parent system page. Therefore, in the related art, the iframe labels are usually given up, and the subsystem page and the parent system page are integrally developed, which increases unnecessary page development costs.

In view of this, the present disclosure provides a method of content presenting to present, in a centered manner, a content box triggered in the subsystem page relative to the parent system page in a scenario of page embedding through the iframe label, thereby reducing the page development cost and improving the page development efficiency.

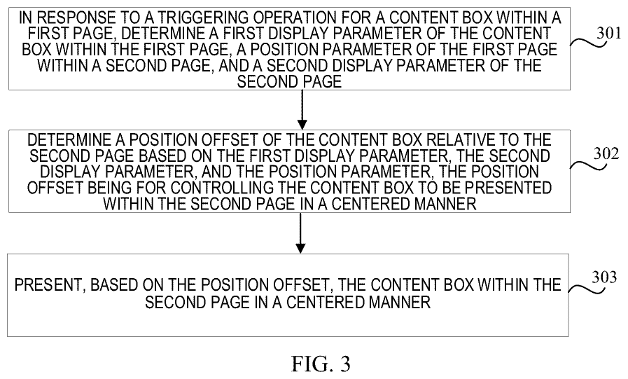

FIG. 3 is a flowchart of a method of content presenting according to an example embodiment of the present disclosure. Referring to FIG. 3, the method of content presenting comprises the following steps.

In step 301, in response to a triggering operation for a content box within a first page, a first display parameter of the content box within the first page, a position parameter of the first page within a second page, and a second display parameter of the second page are determined. Herein, the first page is embedded into the second page through an iframe label for presenting.

In step 302, a position offset of the content box relative to the second page is determined based on the first display parameter, the second display parameter, and the position parameter, the position offset being for controlling the content box to be presented within the second page in a centered manner.

In step 303, the content box within the second page is presented in a centered manner based on the position offset.

As an example, if the first page is embedded into the second page through the iframe label, in page inheritance of a plurality of business systems, the first page may be a subsystem page and the second page may be a parent system page.

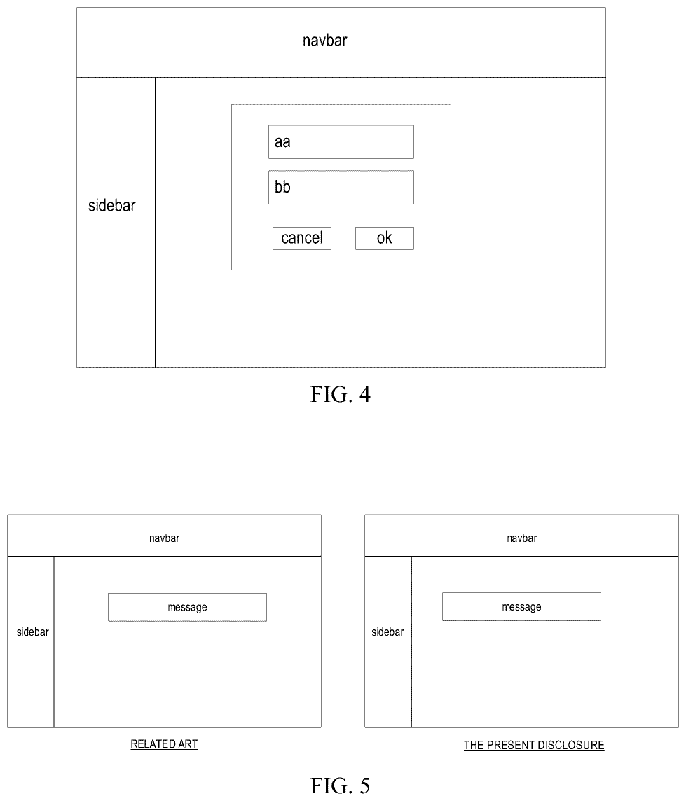

As an example, the content box may comprise a modal box configured to receive a user interactive operation in a page, or a message box configured to notify a user with a message in the page. In the case that the triggered content box is the modal box configured to receive the user interactive operation in the page, referring to FIG. 2, according to a mode in the related art, the modal box is centered relative to a width of the subsystem page. Referring to FIG. 4, according to a mode of content presenting provided by the present disclosure, the modal box may be presented on the whole page in a centered manner. If the triggered content box is the message box configured to notify the user with a message in the page, referring to the left part of FIG. 5, according to a mode in the related art, the message box is centered relative to the width of the subsystem page. Referring to the right part of FIG. 5, according to the mode of content presenting provided by the present disclosure, the message box may be centered relative to the width of the whole page.

The triggering operation for the content box is an operation for triggering presenting of the content box. If the content box is the modal box configured to receive the user interactive operation in the page, the triggering operation may be an operation of clicking, long pressing or the like for existing controls within the first page. If the content box is the message box configured to notify the user with a message in the page, the triggering operation may be a receiving operation or a generating operation for the message by a user terminal.

For example, when the user clicks a “Submit” button within the first page, a modal box configured to ask the user whether to confirm the submission may be presented. The modal box may present a first control for the user to select “Yes” and a second control for the user to select “No”. In this scenario, the operation of clicking the “Submit” button is the triggering operation for the modal box. For another example, the user terminal receives a message from other users, and the message box for message notifying may be presented. In this scenario, the receiving operation for the message by the user terminal is the triggering operation for the message box.

In an embodiment of the present disclosure, in response to the triggering operation for the content box within the first page, the first display parameter of the content box within the first page, the position parameter of the first page within the second page, and the second display parameter of the second page may be determined.

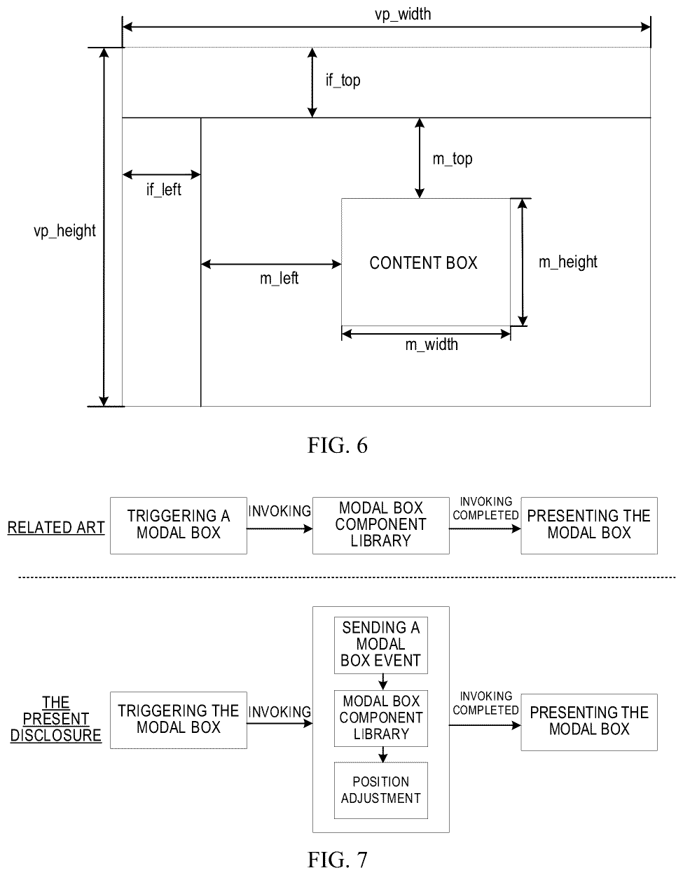

For example, referring to FIG. 6, the first display parameter of the content box within the first page may comprise a first width offset m_left of the triggered content box relative to the first page, a first height offset m_top of the content box relative to the first page, a width m_width of the content box and a height m_height of the content box. The position parameter of the first page within the second page may comprise a second width offset if left of the first page relative to the second page and a second height offset if_top of the first page relative to the second page. The second display parameter may comprise a width vp_width of the second page and a height vp_height of the second page. The specific content of the first display parameter, the position parameter and the second display parameter is not limited in the embodiment of the present disclosure.

In a possible mode, determining a first display parameter of the content box within the first page may comprise: invoking a target content box in a content box component library based on content box identification information comprised in the triggering operation, wherein a plurality of content boxes are predetermined in the content box component library, and each content box in the content box component library has a predetermined display parameter for controlling a corresponding content box to be presented in a centered manner within a page where the content box is triggered; and determining the predetermined display parameter of the target content box as the first display parameter.

It should be understood that in the related art, the process of presenting of the content box comprises: triggering the content box, then invoking the corresponding content box in the content box component library based on the content box identification information comprised in the triggering operation, and finally presenting the invoked content box. For example, referring to the upper part of FIG. 7, after the modal box is triggered, the corresponding modal box is invoked in a modal box component library, and then the invoked modal box is presented. However, in the scenario of page embedding through the iframe label, this mode cannot enable the content box to be presented in a centered manner relative to the embedded page (that is, the second page or the parent system page mentioned above).

In an embodiment of the present disclosure, after the content box is triggered, the target content box may be invoked in the content box component library based on the content box identification information comprised in the triggering operation. The plurality of content boxes is predetermined in the content box component library, each content box in the content box component library has the predetermined display parameter for controlling a corresponding content box to be presented in a centered manner within a page where the content box is triggered. Then, the predetermined display parameters of the target content box may be determined as the first display parameter, so that the position offset may be subsequently determined based on the first display parameter, and a display position of the content box is adjusted based on the position offset, so as to finally implement central presenting of the content box within the embedded page.

For example, referring to the lower part of FIG. 7, after the modal box is triggered, a modal box event is sent to a modal box component library, and the modal box event may be generated based on the triggering operation for the modal box and may comprise identification information of the triggered modal box. Then, a target modal box is invoked from the modal box component library based on the identification information to obtain predetermined display parameters of the target modal box, that is, the first display parameter may be obtained. Afterwards, a display position of the modal box may be adjusted based on the first display parameter. In this process, the end of position adjustment of the modal box is the end of invoking of the modal box. Finally, the modal box may be presented in a centered manner on the embedded page.

In the above mode, in the scenario of page embedding through the iframe label, interception processing may be performed in the process of invoking the content box component library, so that the position of the invoked content box is adjusted to implement central presenting of the content box within the embedded page. Such interception processing encapsulates the original content box component library and has no interference with a business party (such as a business system or business system page of triggering the content box) and invoking results, which can further reduce the page development cost and improve the page development efficiency.

In a possible mode, the position parameter of the first page within the second page is recorded in page source code of the second page. Correspondingly, in response to a triggering operation for a content box within the first page, determining a position parameter of the first page within the second page may comprise: in response to a triggering operation for the content box within the first page, sending a notification event to the second page, the notification event being for triggering the second page to return the position parameter of the first page within the second page recorded in the page source code, and then receiving the position parameter of the first page within the second page returned by the second page.

It should be understood that the first page is embedded into the second page through the iframe label, and the position parameter of the first page within the second page will be recorded in the page source code of the second page in a development process. Therefore, in order to reduce unnecessary parameter determination operations, the embodiment of the present disclosure may directly obtain the position parameter of the first page within the second page from the page source code of the second page. However, the first page is embedded into the second page through the iframe label, the iframe label has independence, and components and styles of the page embedded through the iframe label are isolated from the embedded page. Therefore, in the embodiment of the present disclosure, firstly in response to the triggering operation for the content box within the first page, the first page sends the notification event to the second page to trigger the second page to return the position parameter of the first page within the second page recorded in the page source code. Afterwards, the first page receives the position parameter of the first page within the second page returned by the second page. In this process, the communication between the first page and the second page may be implemented through PostMessage, which will not be limited in the embodiment of the present disclosure.

Therefore, in the case that the first page and the second page are isolated from each other, the position parameter of the first page within the second page recorded in the page source code of the second page may be obtained, and no additional position determination operation is required to determine the position parameter of the first page within the second page, which can further reduce the page development cost and improve the page development efficiency.

After determining the first display parameter of the content box within the first page, the position parameter of the first page within the second page, and the second display parameter of the second page, the position offsets of the content box relative to the second page may be determined based on the first display parameter, the second display parameter and the position parameter.

In a possible mode, determining a first display parameter of the content box within the first page, a position parameter of the first page on a second page and a second display parameter of the second page may comprise: determining a first width offset of the content box relative to the first page, a first height offset of the content box relative to the first page, a width of the content box, and a height of the content box as the first display parameter of the content box within the first page; determining a second width offset of the first page relative to the second page, and a second height offset of the first page relative to the second page as the position parameter of the first page within the second page; and determining a width of the second page and a height of the second page as the second display parameter.

That is, the position offsets of the content box relative to the second page may be subsequently determined based on the first width offset, the first height offset, the width of the content box, the height of the content box, the second width offset, the second height offset, the width of the second page and the height of the second page.

In a possible mode, the first width offset, the second width offset, and a half of the width of the content box may be subtracted from a half of the width of the second page, to obtain a target width offset of the content box relative to the second page, wherein a positive or negative sign of the target width offset characterizes a width offset direction of the content box relative to the second page. The first height offset, the second height offset, and a half of the height of the content box may be subtracted from a half of the height of the second page, to obtain a target height offset of the content box relative to the second page, wherein a positive or negative sign of the target height offset characterizes a height offset direction of the content box relative to the second page. Then, the target width offset, and the target height offset are determined as position offsets of the content box relative to the second page.

For example, referring to FIG. 6, the target width offset, and the target height offset may be determined based on the following formulas:

$$offset\_x = vp\_width / 2 - if\_left - m\_left - m\_width / 2 \\ offset\_y = vp\_height / 2 - if\_top - m\_top - m\_height / 2$$

Herein, offset_x represents the target width offset, the positive sign represents a right offset, the negative sign represents a left offset, offset_y represents the target height offset, the positive sign represents an upward offset, and the negative sign represents a downward offset.

In this mode, in the scenario of page embedding through the iframe label, the change and interference to the content box are smaller, and the calculated offsets can be directly transmitted to the content box for position adjustment without a need for repeated calculation, which can not only implement an effect of centering the content box relative to the embedded page, but also reduce the page development cost and improve the page development efficiency.

It should be understood that in practical applications, the position offsets of the content box relative to the second page may also be determined in other modes based on the first width offset, the first height offset, the width of the content box, the height of the content box, the second width offset, the second height offset, the width of the second page and the height of the second page, which is not limited in the embodiment of the present disclosure.

After determining the position offsets of the content box relative to the second page, the content box may be presented within the second page in a centered manner based on the position offsets.

As an example, an original display position parameter of the content box may be adjusted based on the position offset to obtain a target position parameter for presenting the content box within the second page in a centered manner. Therefore, the presenting of the content box is controlled based on the target position parameter and the central presenting of the content box within the second page is implemented.

For example, referring to the mode described above, the original display position parameters of the content box may be a parameter of presenting the content box relative to the first page in a centered manner, and comprise a width position parameter of a center point of the content box along a width direction and a height position parameter of the center point of the content box along a height direction when the content box is presented in a centered manner within the first page. Moreover, the position offsets may comprise the target height offset, and the target width offset of the content box relative to the second page, wherein the target height offset is configured to control the content box to be centered in the height of the second page and the target width offset is configured to control the content box to be centered in the width of the second page. Correspondingly, the width position parameter may be adjusted based on the target width offset, and the height position parameter may be adjusted based on the target height offset, such that the content box is presented within the second page in a centered manner.

In practical applications, when one modal box is opened, it is expected that the user will interact with the modal box, but other user interface objects except the modal box cannot interact with the user. Therefore, the presenting of the modal box may correspondingly have a background mask to shield the interaction between other user interface objects and the user. In the scenario of page embedding through the iframe label, after an embedding page (i.e., the first page) triggers the modal box, since the embedding page and the embedded page are isolated from each other, the background mask of the modal box is only for the embedding page, but not for the embedded page, leading to that an unmasked area within the embedded page may respond to the interaction of the user, which does not meet expected display requirements of the modal box in actual business.

In order to solve this problem, according to the present disclosure, the background mask may be also presented on an upper layer of the second page while the content box is presented within the second page in a centered manner based on the position offset, and the background mask is configured to cover the page display area corresponding to the second page.

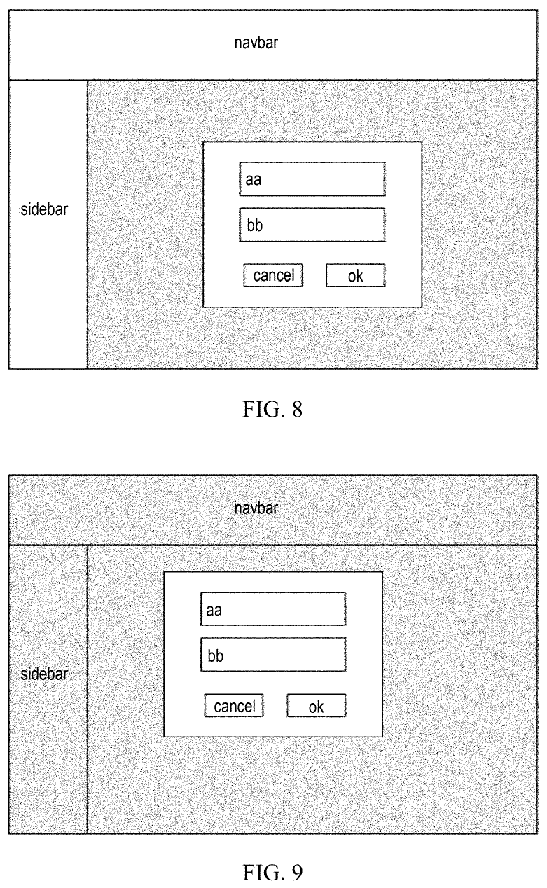

For example, referring to FIG. 8, the background mask of the modal box is illustrated in a gray scale area. According to a mode of the related art, the background mask of the modal box is only for the subsystem page (i.e., the first page). A navbar area and a sidebar area in the parent system page are not covered by the background mask, that is, the navbar area and sidebar area in the parent system page can respond to the interaction of the user, which does not meet the expected display requirements of the modal box in actual business. However, according to the mode provided by the embodiment of the present disclosure, referring to FIG. 9, when the modal box is presented in a centered manner relative to the whole page (i.e., the second page), the background mask of the modal box may cover the whole page (i.e., the second page), the user may interact with the modal box, while other user interface objects except the modal box cannot interact with the user, which meets the expected display requirements of the modal box in actual business.

In the above mode, when the content box is presented within the second page in a centered manner, the background mask corresponding to the content box may be presented for the whole second page, so as to avoid the interaction between the user and page objects except the content box in a process of presenting of the content box, which can not only meet the expected display requirements of the modal box in actual business, but also reduce unnecessary page development costs and improve the page development efficiency.

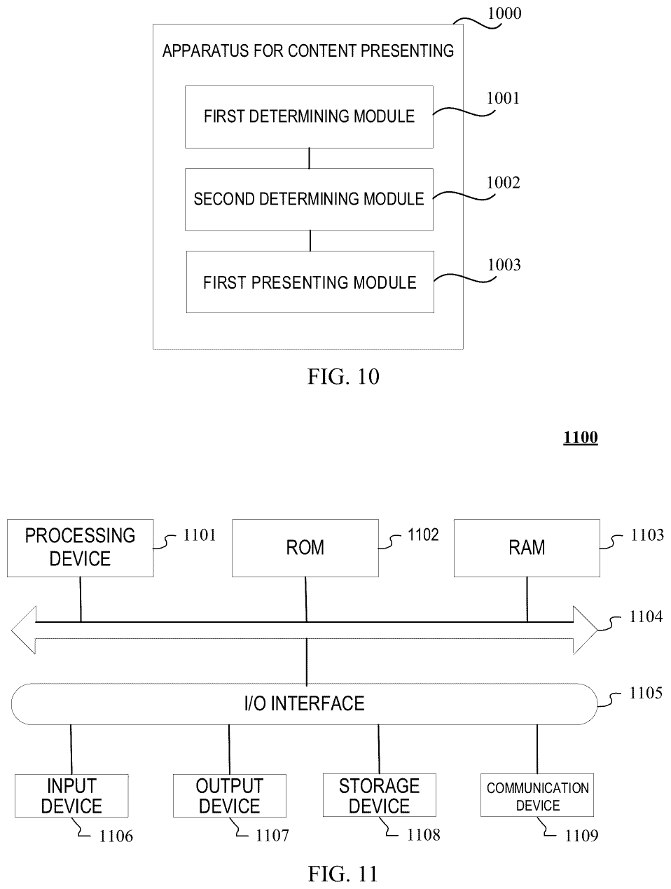

Based on the same inventive concept, embodiments of the present disclosure also provide an apparatus for content presenting, which may be part or all of an electronic device by means of software, hardware, or a combination of both. Referring to FIG. 10, the apparatus for content presenting 1000 comprises:
a first determining module 1001 configured to, in response to a triggering operation for a content box within a first page, determine a first display parameter of the content box within the first page, a position parameter of the first page within a second page, and a second display parameter of the second page, the first page being embedded into the second page through an iframe label for presenting;
a second determining module 1002 configured to determine a position offset of the content box relative to the second page based on the first display parameter, the second display parameter, and the position parameter, the position offset being for controlling the content box to be presented within the second page in a centered manner; and
a first presenting module 1003 configured to present, based on the position offset, the content box within the second page in a centered manner.

In some embodiments, the apparatus 1000 further comprises:
a second presenting module configured to, if the content box is presented within

the second page in a centered manner based on the position offset, present a background mask on an upper layer of the second page, the background mask being for covering a page display area corresponding to the second page.

In some embodiments, the content box comprises: a modal box for receiving a user interactive operation on a page or a message box for notifying a user with a message in the page.

In some embodiments, the position parameter of the first page within the second page being recorded in page source code of the second page, the first determining module 1001 comprises:
in response to a triggering operation for the content box within the first page, sending a notification event to the second page, the notification event being for triggering the second page to return the position parameter of the first page within the second page recorded in the page source code; and
receiving the position parameter of the first page within the second page returned by the second page.

In some embodiments, the first determining module 1001 is configured to:
invoke a target content box in a content box component library based on content box identification information comprised in the triggering operation, wherein a plurality of content boxes are predetermined in the content box component library, and each content box in the content box component library has a predetermined display parameter for controlling a corresponding content box to be presented in a centered manner within a page where the content box is triggered; and
determine the predetermined display parameter of the target content box as the first display parameter.

In some embodiments, the first determining module 1001 is configured to:
determine a first width offset of the content box relative to the first page, a first height offset of the content box relative to the first page, a width of the content box, and a height of the content box as the first display parameter of the content box within the first page; determining a second width offset of the first page relative to the second page, and a second height offset of the first page relative to the second page as the position parameter of the first page within the second page; and determining a width of the second page and a height of the second page as the second display parameter.

In some embodiments, the second determining module 1002 is configured to:
subtract the first width offset, the second width offset, and a half of the width of

the content box from a half of the width of the second page, to obtain a target width offset of the content box relative to the second page, wherein a positive or negative sign of the target width offset characterizes a width offset direction of the content box relative to the second page;
subtract the first height offset, the second height offset, and a half of the height of the content box from a half of the height of the second page, to obtain a target height offset of the content box relative to the second page, wherein a positive or negative sign of the target height offset characterizes a height offset direction of the content box relative to the second page;
determine the target width offset and the target height offset as position offsets of the content box relative to the second page.

With respect to the apparatus in the above embodiment, the specific manner in which each module performs an operation has been described in detail in the embodiments relating to the method and will not be described in detail herein.

Based on the same conception, the present disclosure also provides a non-transitory computer-readable medium having a computer program stored thereon, wherein the program, when executed by a processing device, implements the steps of any of the above method of content presenting.

Based on the same conception, the present disclosure also provides an electronic device, comprising:
a storage device having a computer program stored thereon; and
a processing device for executing the computer program in the storage device to implements the steps of any of the above method of content presenting.

Refer to FIG. 11, which shows a schematic diagram of an electronic device 1100 according to an embodiment of the present disclosure. The terminal device in the embodiment of the present disclosure may comprise but is not limited to a mobile terminal, such as a mobile phone, a notebook computer, a digital broadcast receiver, a personal digital assistant (PDA), a tablet computer (PAD), a portable multimedia player (PMP), an onboard terminal (such as an onboard navigation terminal), and a fixed terminal, such as a digital TV and a desktop computer. The electronic device shown in FIG. 11 is only an example and should not limit the function and disclosure range of the embodiments of the present disclosure.

As shown in FIG. 11, the electronic device 1100 may comprise a processing device (such as a central processing unit, a graphics processing unit, or the like) 601 that may perform various appropriate actions and processing according to a program stored in a read-only memory (ROM) 1102 or a program loaded from a storage device 1108 into a random-access memory (RAM) 1103. In the RAM 1103, various programs and data required for operation of the electronic device are further stored. The processing device 1101, the ROM 1102, and the RAM 1103 are connected to each other by using a bus 1104. An input/output (I/O) interface 1105 is also connected to the bus 1104.

Generally, the following devices may be connected to the I/O interface 1105: an input device 1106 comprising, for example, a touchscreen, a touchpad, a keyboard, a mouse, a camera, a microphone, an accelerometer, and a gyroscope; an output device 1107 comprising, for example, a liquid crystal display (LCD), a loudspeaker and a vibrator; a storage device 1108 comprising, for example, a tape or a hard disk; and a communication device 1109. The communication device 1109 may allow the electronic device to communicate wirelessly or wiredly with another device to exchange data. Although FIG. 11 shows an electronic device 1100 with various devices, it should be understood that it is not required to implement or provide all shown devices. Alternatively, more or fewer devices may be implemented or provided.

In particular, according to the embodiments of the present disclosure, the process described above with reference to the flowchart may be implemented as a computer software program. For example, an embodiment of the present disclosure comprises a computer software program product that comprises a computer program carried on a readable medium, and the computer program includes program code used to perform the methods shown in the flowchart. In such an embodiment, the computer program may be downloaded and installed from a network by using the communication device 1109, installed from the storage device 1108, or installed from the ROM 1102. When the computer program is executed by the processing device 1101, the foregoing functions defined in the method in the embodiments of the present disclosure are executed.

It should be noted that the foregoing computer-readable medium in the present disclosure may be a computer-readable signal medium, a computer-readable storage medium, or any combination of the two. The computer-readable storage medium may be, for example, an electrical, magnetic, optical, electromagnetic, infrared, or semiconductor system, apparatus, or device, or any combination thereof. More specific examples of the computer-readable storage medium may comprise but are not limited to: an electrical connection having one or more conducting wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that includes or stores a program, and the program may be used by or in combination with an instruction execution system, apparatus, or device. In the present disclosure, the computer-readable signal medium may comprise a data signal propagated in a baseband or as a part of a carrier, which carries computer-readable program code. Such a propagated data signal may be in a plurality of forms, comprising but not limited to an electromagnetic signal, an optical signal, or any suitable combination thereof. The computer-readable signal medium may further be any computer-readable medium other than the computer-readable storage medium, and the computer-readable signal medium may send, propagate, or transmit a program that is used by or in combination with an instruction execution system, apparatus, or device. The program code comprised in the computer-readable medium may be transmitted by using any suitable medium, including but not limited to: a wire, an optical cable, a radio frequency (RF), or any suitable combination thereof.

In some embodiments, the client and the server can communicate by using any currently known or future-developed network protocol, for example, an HTTP (Hyper Text Transfer Protocol), and can be interconnected by a communication network of any form or any medium. Examples of the communication network comprise a local area network (LAN), a wide area network (WAN), an internet network (for example, the Internet), and an end-to-end network (for example, an ad hoc end-to-end network), and any currently known or future-developed network.

The computer readable medium may be included in the foregoing electronic device, or may exist separately and not be assembled into the electronic device.

The above computer-readable medium carries one or more programs, and the above one or more programs, when executed by the electronic device, enable the electronic device to, in response to a triggering operation for a content box within a first page, determine a first display parameter of the content box within the first page, a position parameter of the first page within a second page, and a second display parameter of the second page, the first page being embedded into the second page through an iframe label for presenting; determine a position offset of the content box relative to the second page based on the first display parameter, the second display parameter, and the position parameter, the position offset being for controlling the content box to be presented within the second page in a centered manner; and present, based on the position offset, the content box within the second page in a centered manner.

Computer program code for performing the operations of the present disclosure may be written in one or more programming languages or a combination thereof, such as object-oriented programming languages Java, Smalltalk, C++, and conventional procedural programming languages such as “C” or similar program design languages. The program code may be executed completely on a user computer, partially on a user computer, as an independent package, partially on a user computer and partially on a remote computer, or completely on a remote computer or server. In cases involving a remote computer, the remote computer may be connected to a user computer through any type of network, comprising a local area network (LAN) or a wide area network (WAN), or may be connected to an external computer (for example, through the Internet by using an Internet service provider).

Flowcharts and block diagrams in the accompanying drawings illustrate possible architectures, functions, and operations of systems, methods, and computer program products according to various embodiments of the present disclosure. In this regard, each block in a flowchart or block diagram may represent a module, program segment, or part of code that includes one or more executable instructions for implementing a specified logical function. It should also be noted that in some alternative implementations, functions marked in the block may also occur in different order than those marked in the accompanying drawings. For example, two blocks represented in succession may actually be executed in substantially parallel, and they may sometimes be executed in a reverse order, depending on the functions involved. It should also be noted that each block in the block diagram and/or flowchart and a combination of blocks in the block diagram and/or flowchart may be implemented by using a dedicated hardware-based system that performs a specified function or operation, or may be implemented by using a combination of dedicated hardware and a computer instruction.

The units described in embodiments of the present disclosure may be implemented either by means of software or by means of hardware. The names of these units do not limit the units themselves under certain circumstances.

Various functions described herein above can be implemented by one or more hardware logic members. For example and without limitations thereto, an example hardware logic member comprises a field programmable gate array (FPGA), a disclosure-specific integrated circuit (ASIC), a disclosure-specific standard product (ASSP), a system-on-chip system (SOC), a complex programmable logic device (CPLD) or the like.

In the context of the present disclosure, a machine-readable medium may be a tangible medium that may include or store a program for use by or in connection with an instruction execution system, apparatus or device. The machine-readable medium may be a machine-readable signal medium or a machine-readable storage medium. Machine-readable media may comprise, but are not limited to, electronic, magnetic, optical, electromagnetic, infrared, or semiconductor systems, apparatuses or devices, or any suitable combination of the foregoing. More specific examples of machine-readable storage media would comprise one or more wire-based electrical connections, portable computer disks, hard disks, random-access memories (RAMs), read-only memories (ROMs), erasable programmable read-only memories (EPROM or flash memories), fiber optics, portable compact disk read only memories (CD-ROMs), optical storage devices, magnetic storage devices, or any suitable combination of the foregoing.

According to one or more embodiments of the present disclosure, Example 1 provides a method of content presenting. The method comprises:
in response to a triggering operation for a content box within a first page, determining a first display parameter of the content box within the first page, a position parameter of the first page within a second page, and a second display parameter of the second page, the first page being embedded into the second page through an iframe label for presenting;
determining a position offset of the content box relative to the second page based on the first display parameter, the second display parameter, and the position parameter, the position offset being for controlling the content box to be presented within the second page in a centered manner;
presenting, based on the position offset, the content box within the second page in a centered manner.

According to one or more embodiments of the present disclosure, Example 2 provides the method of Example 1, the method further comprising:
if the content box is presented within the second page in a centered manner based on the position offset, presenting a background mask on an upper layer of the second page, the background mask being for covering a page display area corresponding to the second page.

According to one or more embodiments of the present disclosure, Example 3 provides the method of Example 1 or 2, and the content box comprises: a modal box for receiving a user interactive operation on a page or a message box for notifying a user with a message in the page.

According to one or more embodiments of the present disclosure, Example 4 provides the method of Example 1 or 2, the position parameter of the first page within the second page being recorded in page source code of the second page, and wherein in response to a triggering operation for a content box within the first page, determining a position parameter of the first page within the second page comprises:
in response to a triggering operation for the content box within the first page, sending a notification event to the second page, the notification event being for triggering the second page to return the position parameter of the first page within the second page recorded in the page source code;
receiving the position parameter of the first page within the second page returned by the second page.

According to one or more embodiments of the present disclosure, Example 5 provides the method of Example 1 or 2, and determining a first display parameter of the content box within the first page comprises:
invoking a target content box in a content box component library based on content box identification information comprised in the triggering operation, wherein a plurality of content boxes are predetermined in the content box component library, and each content box in the content box component library has a predetermined display parameter for controlling a corresponding content box to be presented in a centered manner within a page where the content box is triggered;
determining the predetermined display parameter of the target content box as the first display parameter.

According to one or more embodiments of the present disclosure, Example 6 provides the method of Example 1 or 2, and determining a first display parameter of the content box within the first page, a position parameter of the first page on a second page and a second display parameter of the second page comprises:
determining a first width offset of the content box relative to the first page, a first height offset of the content box relative to the first page, a width of the content box, and a height of the content box as the first display parameter of the content box within the first page; determining a second width offset of the first page relative to the second page, and a second height offset of the first page relative to the second page as the position parameter of the first page within the second page; and determining a width of the second page and a height of the second page as the second display parameter.

According to one or more embodiments of the present disclosure, Example 7 provides the method of Example 1 or 2, and determining a position offset of the content box relative to the second page based on the first display parameter, the second display parameter, and the position parameter of the first page within the second page comprises:
subtracting the first width offset, the second width offset, and a half of the width of the content box from a half of the width of the second page, to obtain a target width offset of the content box relative to the second page, wherein a positive or negative sign of the target width offset characterizes a width offset direction of the content box relative to the second page;
subtracting the first height offset, the second height offset, and a half of the height of the content box from a half of the height of the second page, to obtain a target height offset of the content box relative to the second page, wherein a positive or negative sign of the target height offset characterizes a height offset direction of the content box relative to the second page;
determining the target width offset and the target height offset as position offsets of the content box relative to the second page.

According to one or more embodiments of the present disclosure, Example 8 provides an apparatus for content presenting, comprising:
a first determining module configured to, in response to a triggering operation for a content box within a first page, determine a first display parameter of the content box within the first page, a position parameter of the first page within a second page, and a second display parameter of the second page, the first page being embedded into the second page through an iframe label for presenting;
a second determining module configured to determine a position offset of the content box relative to the second page based on the first display parameter, the second display parameter, and the position parameter, the position offset being for controlling the content box to be presented within the second page in a centered manner;
a first presenting module configured to present, based on the position offset, the content box within the second page in a centered manner.

According to one or more embodiments of the present disclosure, Example 9 provides a computer-readable medium having a computer program stored thereon, wherein the program, when executed by a processing device, implements the steps of the method of any of Examples 1 to 7.

According to one or more embodiments of the present disclosure, Example 10 provides an electronic device, comprising:
a storage device having a computer program stored thereon;
a processing device for executing the computer program in the storage device to implement the steps of the method of any of Examples 1 to 7.

The above description is only a preferred embodiment of the present disclosure and an illustration of the technical principles utilized. It should be understood by those skilled in the art that the scope of disclosure involved in the present disclosure is not limited to technical solutions formed by a particular combination of the above technical features, but also covers other technical solutions formed by any combination of the above technical features or their equivalent features without departing from the above disclosed concept, for example, a technical solution formed by interchanging the above features with (but not limited to) technical features with similar functions disclosed in the present disclosure.

Furthermore, while the operations are depicted using a particular order, this should not be construed as requiring that the operations be performed in the particular order shown or in sequential order of execution. Multitasking and parallel processing may be advantageous in certain environments. Similarly, while several specific implementation details are included in the above discussion, these should not be construed as limiting the scope of the present disclosure. Certain features described in the context of separate embodiments may also be implemented in combination in a single embodiment. Conversely, various features described in the context of a single embodiment may also be implemented in a plurality of embodiments, either individually or in any suitable sub-combination.

Although the present subject matter has been described using language specific to structural features and/or method logical actions, it should be understood that the subject matter limited in the appended claims is not necessarily limited to the particular features or actions described above. Rather, the particular features and actions described above are merely example forms of implementing the claims. With respect to the apparatus in the above embodiments, the specific manner in which the individual modules perform the operations has been described in detail in the embodiments relating to the method and will not be described in detail herein.

1. A method of content presenting, wherein the method comprises:
in response to a triggering operation for a content box within a first page, determining a first display parameter of the content box within the first page, a position parameter of the first page within a second page, and a second display parameter of the second page, the first page being embedded into the second page through an iframe label for presenting;
determining a position offset of the content box relative to the second page based on the first display parameter, the second display parameter, and the position parameter, the position offset being for controlling the content box to be presented within the second page in a centered manner; and
presenting, based on the position offset, the content box within the second page in a centered manner.

2. The method of claim 1, wherein the method further comprises:
if the content box is presented within the second page in a centered manner based on the position offset, presenting a background mask on an upper layer of the second page, the background mask being for covering a page display area corresponding to the second page.

3. The method of claim 1, wherein the content box comprises:
a modal box for receiving a user interactive operation on a page or a message box for notifying a user with a message in the page.

4. The method of claim 1, wherein the position parameter of the first page within the second page being recorded in page source code of the second page, and wherein in response to a triggering operation for a content box within the first page, determining a position parameter of the first page within the second page comprises:
in response to a triggering operation for the content box within the first page, sending a notification event to the second page, the notification event being for triggering the second page to return the position parameter of the first page within the second page recorded in the page source code; and
receiving the position parameter of the first page within the second page returned by the second page.

5. The method of claim 1, wherein determining a first display parameter of the content box within the first page comprises:
invoking a target content box in a content box component library based on content box identification information comprised in the triggering operation, wherein a plurality of content boxes are predetermined in the content box component library, and each content box in the content box component library has a predetermined display parameter for controlling a corresponding content box to be presented in a centered manner within a page where the content box is triggered; and
determining the predetermined display parameter of the target content box as the first display parameter.

6. The method of claim 1, wherein determining a first display parameter of the content box within the first page, a position parameter of the first page on a second page and a second display parameter of the second page comprises:
determining a first width offset of the content box relative to the first page, a first height offset of the content box relative to the first page, a width of the content box, and a height of the content box as the first display parameter of the content box within the first page; determining a second width offset of the first page relative to the second page, and a second height offset of the first page relative to the second page as the position parameter of the first page within the second page; and determining a width of the second page and a height of the second page as the second display parameter.

7. The method of claim 6, wherein determining a position offset of the content box relative to the second page based on the first display parameter, the second display parameter, and the position parameter of the first page within the second page comprises:
subtracting the first width offset, the second width offset, and a half of the width of the content box from a half of the width of the second page, to obtain a target width offset of the content box relative to the second page, wherein a positive or negative sign of the target width offset characterizes a width offset direction of the content box relative to the second page;
subtracting the first height offset, the second height offset, and a half of the height of the content box from a half of the height of the second page, to obtain a target height offset of the content box relative to the second page, wherein a positive or negative sign of the target height offset characterizes a height offset direction of the content box relative to the second page; and
determining the target width offset and the target height offset as position offsets of the content box relative to the second page.

8. (canceled)

9. A non-transitory computer-readable medium having a computer program stored thereon, wherein the program, when executed by a processing device, implements the acts comprising:
in response to a triggering operation for a content box within a first page, determining a first display parameter of the content box within the first page, a position parameter of the first page within a second page, and a second display parameter of the second page, the first page being embedded into the second page through an iframe label for presenting;
determining a position offset of the content box relative to the second page based on the first display parameter, the second display parameter, and the position parameter, the position offset being for controlling the content box to be presented within the second page in a centered manner; and
presenting, based on the position offset, the content box within the second page in a centered manner.

10. An electronic device, comprising:
a storage device having a computer program stored thereon; and
a processing device for executing the computer program in the storage device to implement the acts comprising:
in response to a triggering operation for a content box within a first page, determining a first display parameter of the content box within the first page, a position parameter of the first page within a second page, and a second display parameter of the second page, the first page being embedded into the second page through an iframe label for presenting;
determining a position offset of the content box relative to the second page based on the first display parameter, the second display parameter, and the position parameter, the position offset being for controlling the content box to be presented within the second page in a centered manner; and
presenting, based on the position offset, the content box within the second page in a centered manner.

11. The device of claim 10, wherein the acts further comprise:
if the content box is presented within the second page in a centered manner based on the position offset, presenting a background mask on an upper layer of the second page, the background mask being for covering a page display area corresponding to the second page.

12. The device of claim 10, wherein the content box comprises: a modal box for receiving a user interactive operation on a page or a message box for notifying a user with a message in the page.

13. The device of claim 10, wherein the position parameter of the first page within the second page being recorded in page source code of the second page, and wherein in response to a triggering operation for a content box within the first page, determining a position parameter of the first page within the second page comprises:
in response to a triggering operation for the content box within the first page, sending a notification event to the second page, the notification event being for triggering the second page to return the position parameter of the first page within the second page recorded in the page source code; and
receiving the position parameter of the first page within the second page returned by the second page.

14. The device of claim 10, wherein determining a first display parameter of the content box within the first page comprises:
invoking a target content box in a content box component library based on content box identification information comprised in the triggering operation, wherein a plurality of content boxes are predetermined in the content box component library, and each content box in the content box component library has a predetermined display parameter for controlling a corresponding content box to be presented in a centered manner within a page where the content box is triggered; and
determining the predetermined display parameter of the target content box as the first display parameter.

15. The device of claim 10, wherein determining a first display parameter of the content box within the first page, a position parameter of the first page on a second page and a second display parameter of the second page comprises:
determining a first width offset of the content box relative to the first page, a first height offset of the content box relative to the first page, a width of the content box, and a height of the content box as the first display parameter of the content box within the first page;
determining a second width offset of the first page relative to the second page, and a second height offset of the first page relative to the second page as the position parameter of the first page within the second page; and determining a width of the second page and a height of the second page as the second display parameter.

16. The device of claim 15, wherein determining a position offset of the content box relative to the second page based on the first display parameter, the second display parameter, and the position parameter of the first page within the second page comprises:
subtracting the first width offset, the second width offset, and a half of the width of the content box from a half of the width of the second page, to obtain a target width offset of the content box relative to the second page, wherein a positive or negative sign of the target width offset characterizes a width offset direction of the content box relative to the second page;
subtracting the first height offset, the second height offset, and a half of the height of the content box from a half of the height of the second page, to obtain a target height offset of the content box relative to the second page, wherein a positive or negative sign of the target height offset characterizes a height offset direction of the content box relative to the second page; and
determining the target width offset and the target height offset as position offsets of the content box relative to the second page.

17. The medium of claim 9, wherein the acts further comprise:
if the content box is presented within the second page in a centered manner based on the position offset, presenting a background mask on an upper layer of the second page, the background mask being for covering a page display area corresponding to the second page.

18. The medium of claim 9, wherein the content box comprises: a modal box for receiving a user interactive operation on a page or a message box for notifying a user with a message in the page.

19. The medium of claim 9, wherein the position parameter of the first page within the second page being recorded in page source code of the second page, and wherein in response to a triggering operation for a content box within the first page, determining a position parameter of the first page within the second page comprises:
in response to a triggering operation for the content box within the first page, sending a notification event to the second page, the notification event being for triggering the second page to return the position parameter of the first page within the second page recorded in the page source code; and
receiving the position parameter of the first page within the second page returned by the second page.

20. The medium of claim 9, wherein determining a first display parameter of the content box within the first page comprises:
invoking a target content box in a content box component library based on content box identification information comprised in the triggering operation, wherein a plurality of content boxes are predetermined in the content box component library, and each content box in the content box component library has a predetermined display parameter for controlling a corresponding content box to be presented in a centered manner within a page where the content box is triggered; and
determining the predetermined display parameter of the target content box as the first display parameter.

21. The medium of claim 9, wherein determining a first display parameter of the content box within the first page, a position parameter of the first page on a second page and a second display parameter of the second page comprises:
determining a first width offset of the content box relative to the first page, a first height offset of the content box relative to the first page, a width of the content box, and a height of the content box as the first display parameter of the content box within the first page; determining a second width offset of the first page relative to the second page, and a second height offset of the first page relative to the second page as the position parameter of the first page within the second page; and determining a width of the second page and a height of the second page as the second display parameter.
